(19) United States
(12) Patent Application Publication
(10) Pub. No.: US 2007/0126878 A1
(43) Pub. Date: Jun. 7, 2007

(54) Method of providing photo development service in digital TV and apparatus therefor

(75) Inventor: Hee-chul Han, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/600,792

(22) Filed: Nov. 17, 2006

(30) Foreign Application Priority Data
Dec. 5, 2005 (KR) 10-2005-0117670

(51) Int. Cl. H04N 5/225

(52) U.S. Cl. 348/207.99

(57) ABSTRACT

A method of providing a photo development service in a digital TV and an apparatus therefor are provided. The method includes, automatically displaying part or all of the photo images on the screen if an external storage medium storing photo images is connected to a digital TV, and transmitting an image selected by a user from among the displayed images to a website providing a photo development service and requesting development of the image.

### CROSS REFERENCE TO RELATED PATENT APPLICATIONS

This application claims the priority from Korean Patent Application No. 10-2005-0117670, filed on Dec. 5, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to a digital television (TV), and more particularly, to a digital TV providing a variety of services by being connected to a network, in addition to receiving broadcasts.

2. Description of the Related Art

As the convergence of consumer electronic appliances and IT devices has accelerated, a new service to be used at home, in the form of a digital TV portal, has been introduced. The digital TV portal service is a new concept in which, by using a digital TV that can be connected to a network, a user can enjoy a variety of digital contents, such as news, movies, education, music, and games. By manipulating a TV remote control, users can receive a variety of services provided on the Internet through the screen of a digital TV in their living room. However, since the service is still at an early stage, there are not many specific examples of services provided by the digital TV portal.

FIG. 1 is a flowchart of a method of using a photo development service according to a related art technology.

In order to develop a digital photo image, firstly, a user connects a digital camera storing the photo image to a personal computer (PC) in operation 100. If the PC reads images stored in the digital camera and displays the list of the photos, the user copies a desired image and stores it in a predetermined directory of the PC in operation 110.

Then, the user accesses a web page providing a photo development service in operation 120. In the web page providing the photo development service, if the user uploads a photo image desired to be developed through the Internet and registers his or her personal information and address information, the image is developed and the developed photo is deliver to the registered address according to the service. Accordingly, the user uploads images to be developed by using a plug-in program for uploading a file to the web page providing the photo development service in operation 130. Also, information required to pay for the photo development service is transmitted so that the payment is settled in operation 140.

That is, according to the related art method, the user has to personally perform complicated steps, such as copying an image, accessing a web page, uploading a file, and transmitting payment information, and thus the service cannot be easily used by those who are not familiar with PCs. In addition, when the digital TV portal provides a photo development service, the user has to perform the steps with only one remote control. However, the remote control has only a limited number of buttons and thus the user has to perform many key manipulations.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method of enabling a user to use a photo development service provided on the Internet by using a digital TV without having to perform many key manipulations.

According to an aspect of the present invention, there is provided a method of providing a photo development service in a digital TV, the method including: automatically displaying part or all of the photo images on the screen if an external storage medium storing photo images is connected to the digital TV; and transmitting an image selected by a user from among the displayed images to a website providing a photo development service, and requesting development of the image.

In the automatic displaying of some or all of the photo images, only images with a specified format among the images stored in the storage medium may be displayed, or only a specified number of images among the images stored in the storage medium may be displayed.

In the transmitting of the image to the website and the requesting of the development of the image, address information of the user to which a developed photo is to be delivered may be transmitted together with the image selected by the user.

According to another aspect of the present invention, there is provided a computer readable recording medium having embodied thereon a computer program for executing the method.

According to another aspect of the present invention, there is provided an apparatus for providing a photo development service in a digital TV, the apparatus including: an image processing unit that controls the apparatus so that if an external storage medium storing photo images is connected to the digital TV, automatically some or all of the photo images are displayed on the screen; and a development processing unit that transmits some or all of the displayed photo images to a website providing a photo development service according to an input of the user.

The image processing unit may control the apparatus so that only images with a specified format among the images stored in the storage medium are displayed, or only a specified number of images among the images stored in the storage medium are displayed.

The development processing unit may transmit address information of the user, to which a developed photo is to be delivered, to the web site or information required for payment for photo development to the web site.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart of a method of using a photo development service according to a related art technology;

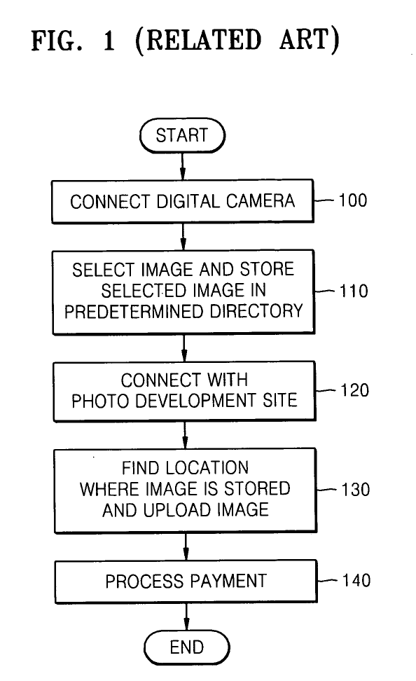

FIG. 2 is a flowchart of a method of providing a photo development service in a digital TV according to an exemplary embodiment of the present invention;

FIG. 3 is a flowchart of a method of providing a photo development service in a digital TV according to another exemplary embodiment of the present invention;

FIG. 4 is a block diagram of a structure of a digital TV according to an exemplary embodiment of the present invention; and

FIG. 5 illustrates a screen displaying images in a digital TV according to an exemplary embodiment of the present invention.

### DETAILED DESCRIPTION OF THE EXEMPLARY EMBODIMENTS OF THE INVENTION

The present invention will now be described more fully with reference to the accompanying drawings, in which exemplary embodiments of the invention are shown.

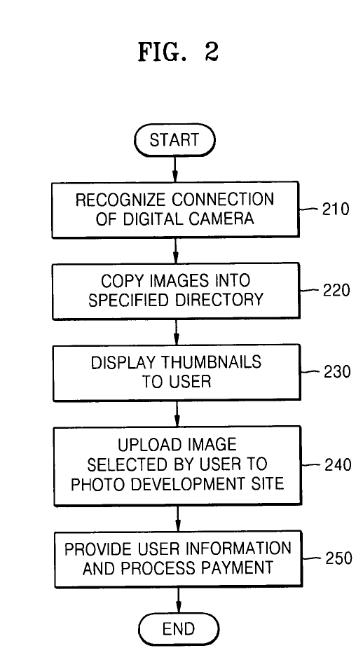

FIG. 2 is a flowchart of a method of providing a photo development service in a digital TV according to an exemplary embodiment of the present invention.

According to the present exemplary embodiment, a user connects a digital camera to a digital TV, and if the digital TV recognizes this connection in operation 210, images stored in the digital camera are automatically copied into a directory in operation 220. In order to connect the digital TV and the digital camera, a variety of interfaces such as an IEEE 1394 interface or universal serial bus (USB) can be used but the interface is not limited thereto. Also, the user may connect a variety of types of storage media that can be connected to the digital TV, as well as the digital camera storing photo images, to the digital TV.

Meanwhile, a directory into which images of the digital camera are copied can be assigned by the user in advance. In the present exemplary embodiment, the copying of all the images stored in the digital camera is explained, but it can also be set in such a way that only images with specified formats or sizes set by the user in advance are copied. For example, according to a setting by the user, only Joint Photographic Experts Group (JPEG) image files are copied or only image files with a size less than 200 kb are copied.

If the copying of the image files is complete, the digital TV displays copied images to the user in operation 230. At this time, for the user's convenience, thumbnails of the copied images may be generated and displayed. Meanwhile, depending on implementations, all the copied images may be displayed or only some of the images may be displayed, depending on the number of images of a specified size that can be displayed on one screen at a time.

Next, if the user selects an image desired to be developed from among displayed images by using a remote control, the image selected by the user is transmitted through the Internet to a web site providing a photo development service in operation 240. An address of a network through which an image to be developed is transmitted may be set by the user in advance. Next, address information of the user to which developed photos are to be delivered and information required for payment are transmitted in operation 250. These information items may also be input by the user in advance and stored in the digital TV. The information required for the payment may be a credit card number, or a mobile phone number, but is not limited to these.

If the digital TV performing the operations described above is used, the user can develop desired images by connecting the digital camera to the digital TV and then selecting photo images with the remote control, without performing additional complicated operations.

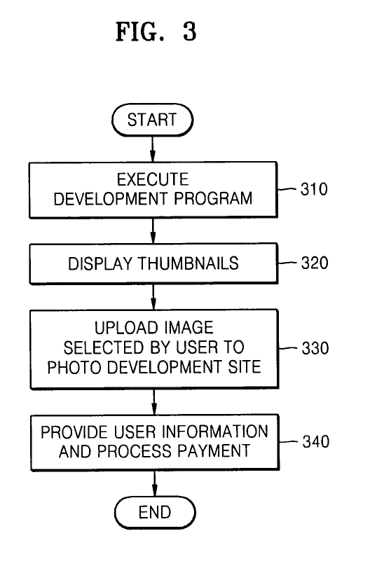

FIG. 3 is a flowchart of a method of providing a photo development service in a digital TV according to another exemplary embodiment of the present invention. The present exemplary embodiment is used in a situation where the user connects a digital camera to a digital TV and completes copying of image files, but then turns off the TV without performing the succeeding process and then turns on the TV later.

Since copying of the image files has been finished already, if the user executes a photo development program by using a remote control in operation 310, a photo development program generates thumbnails of photo images copied before and displays the thumbnails in operation 320.

Next, if the user selects an image desired to be developed from among the displayed images by using the remote control, the development program transmits the image selected by the user to a web site providing a photo development service through the Internet in operation 330, and also transmits address information of the user to which developed photos are to be delivered and information required for payment in operation 340.

That is, operations 320 through 340 are performed by the development program, and in the embodiment of FIG. 2, if it is recognized that the digital TV is connected to the digital camera, this development program is automatically executed.

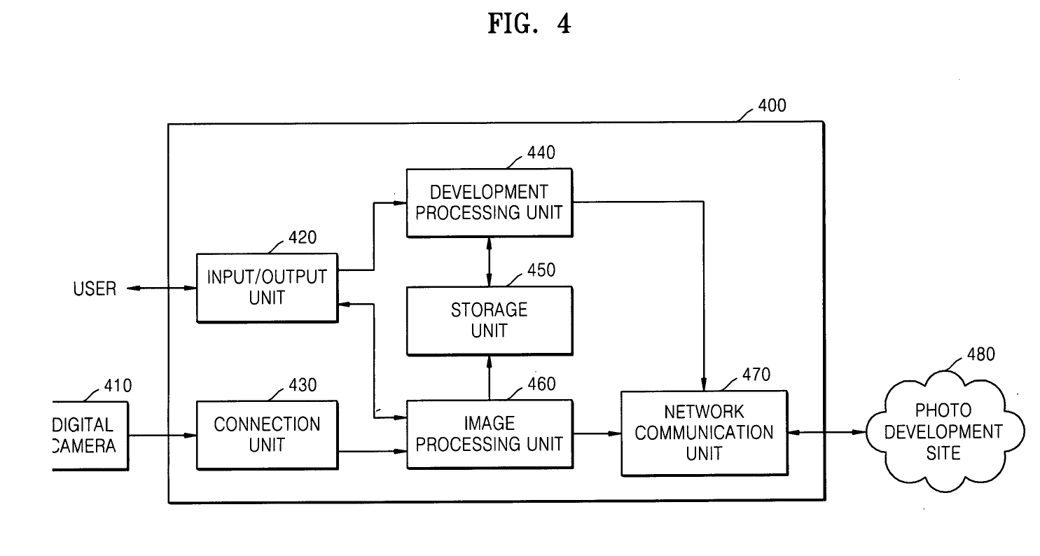

FIG. 4 is a block diagram of a structure of a digital TV according to an exemplary embodiment of the present invention.

As illustrated in FIG. 4, a digital TV 400 according to an exemplary embodiment of the present invention is composed of an input/output unit 420, a connection unit 430, a development processing unit 440, a storage unit 450, an image processing unit 460 and a network communication unit 470. Although the present exemplary embodiment assumes that an apparatus providing a photo development service is implemented in a digital TV, the apparatus can also be implemented as a separate apparatus such as a set-top box.

The input/output unit 420 provides an interface with the user by receiving a remote control input of the user or displaying images to the user. The connection unit 430 provides a connection interface with an external storage medium 410 storing photo images, such as a digital camera or a removable memory. If the external storage medium 410 is connected through the connection unit 430, the image processing unit 460 stores the photo images stored in the external storage medium 410 into the storage unit 450, and generates thumbnails for the images and displays the thumbnails to the user through the input/output unit 420.

The image processing unit 460 may display all images stored in the external storage medium 410, and may also display only images with specified formats set by the user in advance. This setting information is stored in the storage unit 450.

If the user manipulates the remote control and selects all or some of the images displayed by the input/output unit 420, the development processing unit 440 extracts corresponding images from the storage unit 450, and transmits the images to a web site 480 providing a photo development service. The images are transmitted through the network communication unit 470 providing a communication interface with the Internet.

At this time, the development processing unit 440 transmits address information of the user to which developed photos are to be delivered and information required for payment in operation 250. These information items are also stored in the storage unit 450 by the user in advance.

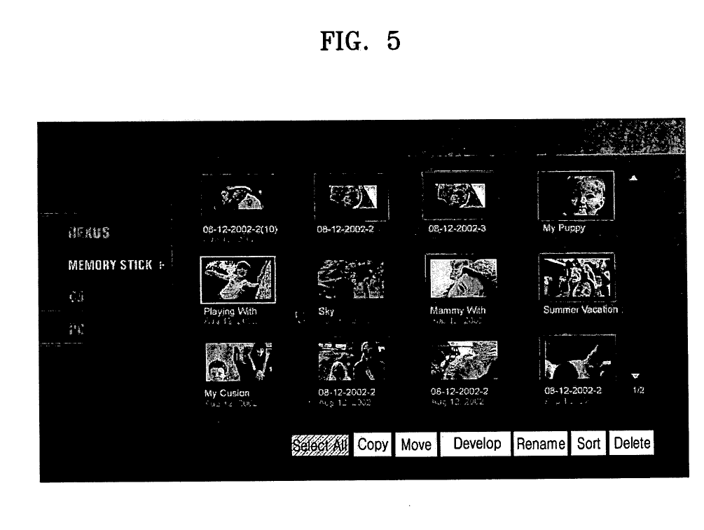

FIG. 5 illustrates a screen displaying images in a digital TV according to an exemplary embodiment of the present invention.

If the user connects a digital camera or a storage medium storing photo images to a digital TV, or if the user turns on the digital TV and executes a development program, a screen as illustrated in FIG. 5 is displayed. Accordingly, if the user selects a desired image from among the displayed images and simply presses a ‘development’ button, the user can user a photo development service.

The present invention can also be exemplarily embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

According to exemplary embodiments of the present invention, when a user connects a digital camera to a digital TV and selects an image desired to be developed, photo images stored in the digital camera can be developed conveniently without performing additional complicated operations.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of providing a photo development service in a digital television (TV), the method comprising:
automatically displaying on a screen of the digital TV at least one image of a plurality of images stored in an external storage medium connected to the digital TV; and
transmitting an image selected by a user from among the at least one image which is displayed to a website which provides a photo development service, and requesting development of the image.

2. The method of claim 1, wherein in the automatic displaying, only images with a specified format among the images stored in the external storage medium are displayed.

3. The method of claim 2, wherein specified format is Joint Photographic Experts Group (JPEG) format.

4. The method of claim 1, wherein in the automatic displaying, a specified number of images among the images stored in the storage medium are displayed.

5. The method of claim 4, wherein the specified number is determined by the size of the images, which is input by the user.

6. The method of claim 1, wherein in the transmitting of the image to the website and the requesting of the development of the image, address information of the user to which a developed photo is to be delivered is transmitted together with the image selected by the user.

7. The method of claim 1, wherein in the transmitting of the image to the website and the requesting of the development of the image, information required for payment for photo development is transmitted to the web site together with the image selected by the user.

8. The method of claim 1, wherein the connection is performed through a universal serial bus (USB)

9. A computer readable recording medium having embodied thereon a computer program for executing a method of providing a photo development service in a digital television (TV), the method comprising:
automatically displaying on a screen of the digital TV at least one image of a plurality of images stored in an external storage medium connected to the digital TV; and
transmitting an image selected by a user from among the at least one image which is displayed to a website which provides a photo development service, and requesting development of the image.

10. An apparatus for providing a photo development service in a digital television (TV), the apparatus comprising:
an image processing unit which controls the apparatus so that if an external storage medium storing photo images is connected to the digital TV, at least one of the photo images is automatically displayed on a screen of the digital TV; and
a development processing unit which transmits the at least one of the displayed photo images to a website providing a photo development service according to an input of the user.

11. The apparatus of claim 10, wherein the image processing unit controls the apparatus so that only images with a specified format among the images stored in the storage medium are displayed.

12. The apparatus of claim 11, wherein specified format is Joint Photographic Experts Group (JPEG) format.

13. The apparatus of claim 10, wherein the image processing unit controls the apparatus so that a specified number of images among the images stored in the storage medium are displayed.

14. The apparatus of claim 13, wherein the specified number is determined by the size of the images, which is input by the user.

15. The apparatus of claim 10, wherein the development processing unit transmits address information of the user, to which a developed photo is to be delivered, to the web site.

16. The apparatus of claim 10, wherein the development processing unit transmits information required for payment for photo development to the web site.

17. The apparatus of claim 10, further comprising a connection unit which provides a connection interface with the external storage medium.

18. The apparatus of claim 17, wherein the connection unit comprises a universal serial bus (USB) interface.

19. The apparatus of claim 10, further comprising an input/output unit which provides an interface for input of the user and outputs the photo images to be displayed.
